(19) United States
(12) Patent Application Publication
(10) Pub. No.: US 2004/0205512 A1
(43) Pub. Date: Oct. 14, 2004

(54) Method,system and processing system for associating uniform resource locator (URL) link data with images created by a camera or other image capture device

(76) Inventors: Rick Paul Hoover, Boise, ID (US); Terry P. Mahoney, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/155,723

(22) Filed: May 24, 2002

(51) Int. Cl. G06F 17/24; G06F 17/21

(52) U.S. Cl. 715/501.1

(57) ABSTRACT

Method, system and processing system for associating text messages and/or uniform resource locator (URL) link data with images created by an image capture device such as a camera. Resource locator links displayed along with the images are activated at the image capture device or at a host processing system to establish communications links and access to remote resources, such as a Web pages, that are associated with the activated resource locator links.

### BACKGROUND OF THE INVENTION

Throughout the history of photography, takers and collectors of photographs have been burdened with the task of remembering and recording information describing the subject matter of the photographs and when the photographs were taken. For decades, diligent people with sufficient available time and the inclination have dutifully annotated the borders or back sides of printed photographs, or pages in albums within which the photographs are (to be) arranged. However, many people simply do not have the time or desire to laboriously record this information and, as a consequence, precious factual information is often forgotten and lost forever because is was not promptly and accurately recorded. In other situations, a person may lack the written skills to properly describe what it is that they saw, or may have perceived things differently than they really were. Also, if a person is moving quickly (“on the run”) and taking photographs in rapid succession, or if their senses are somewhat impaired (e.g., tired or intoxicated), there is a significant likelihood that they will later see a photograph and not recall what was photographed or where exactly they were when it was taken.

At least for these reasons, it would be desirable to be able to mitigate the long-standing and often labor-intensive burden of associating information with recorded images. It would also be desirable to be able to improve the quality and content of information associated with recorded images and to be able to provide such information to the photographer as quickly as possible, e.g., when the photograph is being taken or shortly thereafter. Moreover, it would also be desirable in some circumstances to be able to associate information that does not necessarily describe the recorded image (e.g., advertisements, public service information about or directions to nearby points of interest, attractions, businesses, etc.) with the recorded image.

### SUMMARY OF THE INVENTION

A resource locator is an address of a resource, or file, available on the Internet or other network. The term, uniform resource locator (URL), refers to a type of resource locator that contains the protocol of the resource (e.g., http:// or ftp://), the domain name for the resource, and the hierarchical name for the file (address). URLs can point to Web pages, programs, files or other resources. For purposes of this application, the term “URL” includes all resource locators independent of their format or where the resources are located.

For purposes of this application, the term “image capture device” includes any device capable of capturing an image, such as a (digital) camera, a (digital) video camera, a personal digital assistant (PDA) or mobile telephone with a camera or other image capturing mechanism embedded therein, etc.

According to the present invention, an exemplary method for associating URL link data with images created by an image capture device involves configuring an image capture device to receive URL link data from a wireless transmitter device near the image capture device and storing or linking the URL link data with one or more images created by the image capture device. The (locally) broadcast URL link data are used by the image capture device or some other appliance (e.g., personal computer (PC), PDA, etc.) to display a resource (e.g., a Web page) associated with the URL link data on the image capture device or other appliance. An exemplary system for associating URL link data with images includes an image capture device and means for receiving and processing a signal communicating URL link data and for associating the URL link data with one or more images generated by the image capture device. An exemplary processing system for associating URL link data with images includes a computer configured to receive and process image data including embedded URL link data from an image capture device to generate a visual representation of one or more images associated with the image data and one or more URL links associated with the URL link data. In various embodiments of the present invention, the image capture device, the processing system and/or another (Web-enabled) device is/are configured to allow a user to view images created by the image capture device and URL links associated with these images, select one or more of the URL links, and establish a communications link to one or more resources associated with the URL link(s).

The above described and many other features and attendant advantages of the present invention will become apparent as the invention becomes better understood by reference to the following detailed description when considered in conjunction with the accompanying drawings.

### BRIEF DESCRIPTION OF THE DRAWINGS

Detailed description of preferred embodiments of the invention will be made with reference to the accompanying drawings:

FIG. 1 is a diagram showing an exemplary implementation of the method and system for associating URL link data with images created by an image capture device according to the present invention;

FIG. 2 is a functional diagram showing an exemplary image capture device configured for associating URL link data with images according to the present invention;

FIG. 3 is a flow diagram of an exemplary method for associating URL link data with images created by an image capture device according to the present invention;

FIG. 4 is a flow diagram of an exemplary method for employing an image capture device to establish a communications link to a resource such as a Web page according to the present invention;

FIG. 5 is a diagram showing a processing system for associating URL link data with images according to the present invention; and

FIG. 6 is a flow diagram of an exemplary method for employing a processing system to establish a communications link to a resource such as a Web page according to the present invention.

### DETAILED DESCRIPTION OF THE PREFERRED EMBODIMENTS

The following is a detailed description of the best presently known mode of carrying out the invention. This description is not to be taken in a limiting sense, but is made merely for the purpose of illustrating the general principles of the invention.

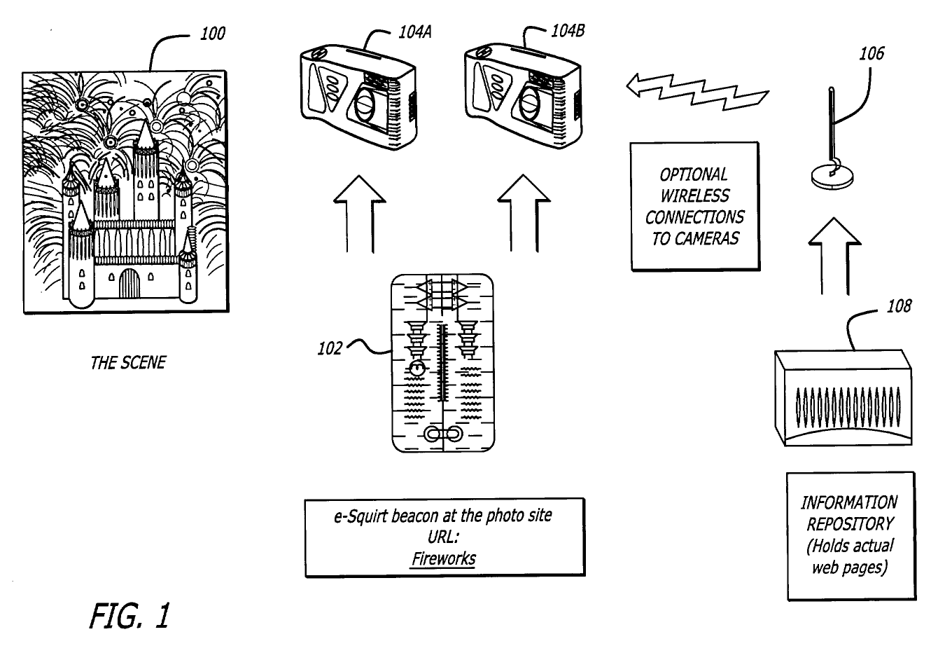

Referring to FIG. 1, an exemplary operating environment 100 for the method and system of the present invention is an outdoor scene, such as a fireworks display (although it should be appreciated that the principles of the present invention are equally applicable to indoor operating environments). According to an embodiment of the present invention, transmitter devices are positioned throughout the operating environment near subjects of likely interest to a person with an image capture device, or near “view points” from which image (e.g., photographs) of such subjects are likely to be taken. In the illustrated example, a beacon 102 is positioned near a location within the operating environment 100 where a person might take a photograph of the scene. The beacons can comprise any transmitter device, for example, beacons employing infrared (IR) technology, beacons with non-directional technologies such radio frequency (RF) based transmitters, Bluetooth transmitters or other wireless technologies. An exemplary beacon transmitter comprises an ESquirt beacon (available from Hewlett-Packard Company of Palo Alto, Calif.) configured to broadcast a string containing a text message and/or URL link data associated with a place or object within the operating environment. In one embodiment, the beacons are programmed to automatically, periodically broadcast a string, e.g., every three seconds. In another embodiment, the beacons include a user input mechanism (such as a button) and instructions that direct a person to actuate the user input mechanism to initiate a beacon broadcast event. For example, a button is pressed for a few seconds (with the user waiting until a green LED blinks before releasing the button). This causes the beacon to transmit its string, by way of example, six times with a three-second interval between transmissions, providing the photographer with a reasonable amount of time to set up for and take a photograph. After the last transmission, the beacon returns to its “sleep” state. In another embodiment, a single beacon is configured to broadcast signals that include URL link data for a plurality of different URLs, for example, cycling through a sequence of several different URLs. In another embodiment, a plurality of beacons are configured together to provide a photographer with a “menu” of different information to select from. For example, a person standing at a view point in Niagara Falls, N.Y. is presented with a button to press in order to initiate transmission of a beacon signal containing URL link data for a resource (such as a Web page) pertaining to the American Falls. A different button might be pressed for the Horseshoe Falls, etc.

The beacons can be “triggered” in other ways, for example, in response to motion, pressure, heat or other sensor devices that detect the presence of a person near a view site. The beacons can also be triggered by the image capture devices. For example, an exemplary image capture device is configured to detect the presence of certain visual codes within a captured image (e.g., the image capture device is provided with image processing capability to facilitate the processing of captured images to identify Universal Product Codes (UPC) that appear within the captured images) and to trigger beacons associated with the detected visual codes. Another exemplary image capture device employs a wireless technology such as RF or IR to trigger the beacon(s), e.g., at the time an image is captured.

A camera (or other image capture device) configured to receive and process the beacon signals according to the present invention facilitates the linking or embedding of the text message and/or URL link data contained in the signals with one or more images generated by the camera. Cameras 104A and 104B are configured in this manner to receive and process the signals broadcast by the beacon 102. Thus, multiple cameras can be taking pictures at the photo site but only one beacon is required at the specific location to transmit the URL to multiple cameras. In one embodiment, the camera is configured to generate a visual representation of the URL link data (e.g., displayed on the camera viewer or other display device in communication with the camera). In another embodiment, the camera is configured to employ the URL link data to establish a wireless communication link to a resource, similar to the operation of Web-enabled devices such as PDAs. By way of example, and referring again to FIG. 1, a transceiver device 106 is employed to establish communications links between the cameras 104A and 104B and an information repository 108 which stores resources such as Web pages, programs, files, text messages, and links to other resources such as audio and/or video messages. In one embodiment, a resource pertains to a subject or place that is within receiving range of a beacon that is broadcasting URL link data associated with that particular resource. However, an URL link contained within the broadcast signal need not necessarily point to such a resource. Alternatively, the URL link data can be used to establish a communication link to resources such as advertisements, public service information about or directions to nearby points of interest, attractions, businesses, etc. For example, in an amusement or theme park, beacons can be configured to broadcast text messages and/or URL data links that provide or point to additional information regarding exhibits, indicate photo opportunities or point to exhibits throughout the park. In another embodiment, the camera is configured to generate a visual representation of the resource (e.g., displayed on the camera viewer or other display device in communication with the camera).

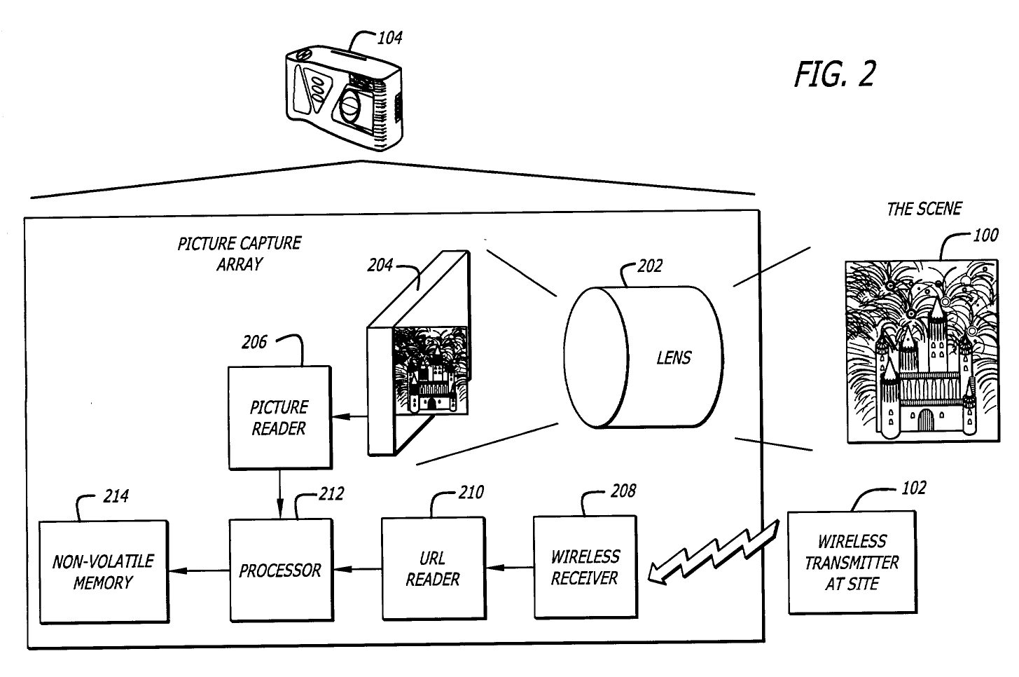

FIG. 2 is a functional diagram of an exemplary embodiment of a camera configured for associating URL link data with images according to the present invention. The major internal functional components of the illustrated exemplary camera 104 comprise a lens 202, a picture capture array 204, a picture reader 206, a wireless receiver 208, an URL reader 210, a processor 212, and a memory device 214 configured as shown. When a photograph is taken, an image is recorded on the picture capture array 204 and then read by the picture reader 206. The signal transmitted by the wireless transmitter 102 is received by the wireless receiver 208 which comprises a receiver designed to process the signal format broadcast by the wireless transmitter 102. By way of example, ESquirt client software available from Hewlett-Packard Company of Palo Alto, Calif. can be used to control receiving the beacon signals. The URL link data contained in the received signal is read by the URL reader 210. The processor 212 then reads the information from the picture reader 206 and the URL reader 210 and stores the information in the memory device 214 which comprises, for example, a non-volatile memory that is either permanently installed in the camera or in a removable format such as Compact Flash, Secure Digital, etc. In one embodiment, the processor 212 automatically attaches the URL to the digital photograph for later reference, thus allowing the user to automatically link detailed information to a digital photograph rather than manually create these links later. Such links advantageously help the user to remember details about what they took the picture of. In another embodiment, the URL link data is permanently embedded with the image data. Thus, in an embodiment of the present invention, the URL link data are permanently associated with the image(s).

Thus, an exemplary method for associating URL link data with images created by a camera according to the present invention includes providing a camera with a receiver and processing electronics configured for receiving and processing a signal communicating text message and/or URL link data and for associating the text message and/or URL link data with one or more images generated by the camera. Another exemplary method for associating URL link data with images created by a camera according to the present invention includes: initiating transmission of a signal communicating URL link data; and employing a camera configured with a receiver and processor electronics to receive and process the signal and to associate the URL link data with an image generated by the camera. In one embodiment, the camera is configured to generate a data file that includes image data and the URL link data associated with image. In another embodiment, the method further includes processing the image data to reproduce the image, for example, by employing the camera processor 212 to process the image data. In another embodiment, the method further includes processing the URL link data to generate a URL link, for example, by employing the camera processor 212 to process the URL link data. In another embodiment, the method further includes employing the URL link to establish a communications link to a resource (e.g., a Web page) associated with the URL.

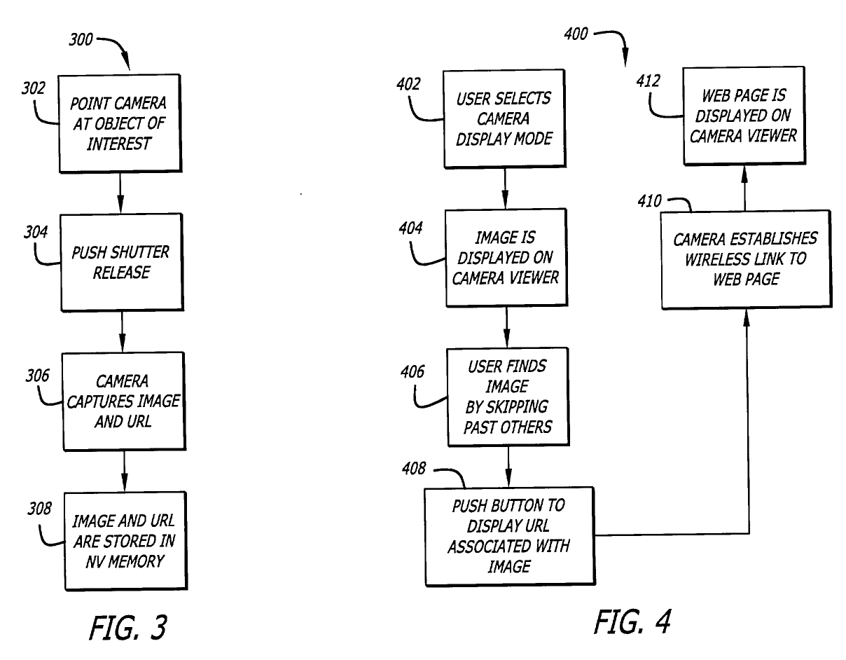

Referring to FIG. 3, an exemplary method 300 for associating URL link data with images created by a camera according to the present invention begins at step 302 by pointing a camera (such as described above) at an object of interest within a “beacon-equipped” environment. At step 304, the shutter release of the camera is pushed. At step 306, the camera captures an image of the object and the URL. At step 308, the image and the URL are stored in the memory device of the camera. Thus, in one embodiment of the present invention, the URL is linked to the digital photo as the image is captured, or very shortly thereafter.

Referring to FIG. 4, an exemplary method 400 for employing a camera to establish a communications link to a resource such as a Web page according to the present invention begins at step 402 with the user selecting the camera display mode. At step 404, one or more stored images are displayed on the camera viewer. At step 406, the user finds a desired image by skipping past other images. At step 408, a user input mechanism (such as a button on the camera) is used to activate a displayed URL link associated with the selected image. At step 410, the camera establishes a wireless communication link to a resource indicated by the URL. At step 412, the resource (e.g., Web page) is displayed on the camera viewer. Thus, an exemplary method for associating URL link data with images created by a camera according to the present invention includes: employing a camera configured with a receiver and processing electronics to receive one or more of the signals and to associate the URL link data with images generated by the camera; and employing the URL link data to establish a wireless communications link to a resource.

Another exemplary method for associating URL link data with images created by a camera according to the present invention includes: providing a plurality of broadcast beacons at different locations; controlling the broadcast beacons to transmit signals communicating URL link data; and employing a camera configured with a receiver and processing electronics to receive one or more of the signals and to associate the URL link data with images generated by the camera. In one embodiment, the method further includes generating a bill to, or debiting an account associated with, a provider of the resource. By way of example, each time the camera establishes a communications link (at step 410) to the Web page, the provider of that Web page (or other resource) is billed, or an account associated with that entity is debited. By monitoring communication links made in this manner, an advertising business model is facilitated whereby providers of content (e.g., advertising) are charged depending upon how much exposure their content receives (e.g., the number of visits to their Web site, advertisement, etc.) as a result of communications links established using particular URL links.

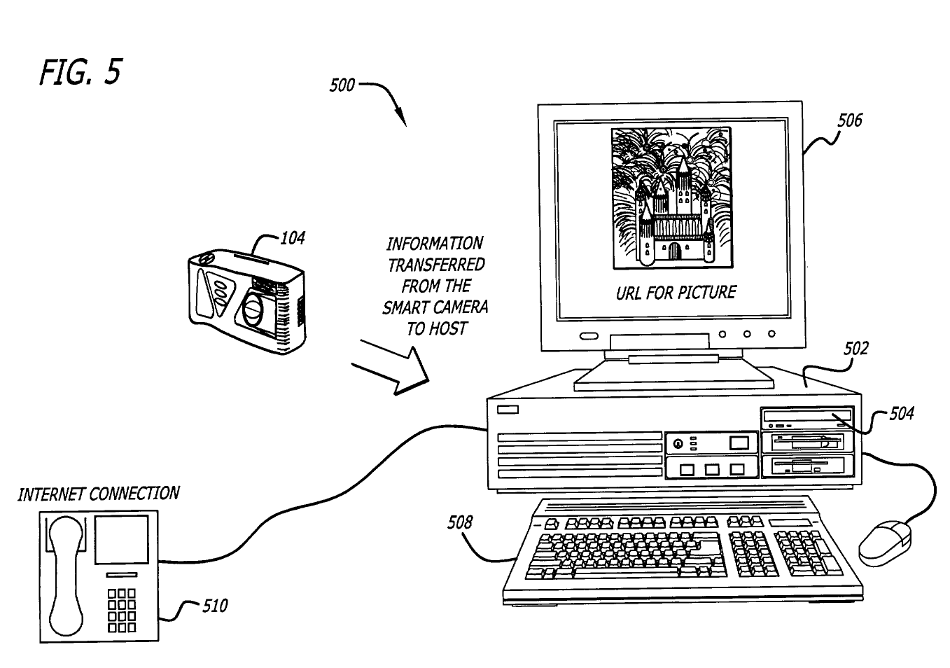

If the camera is not Web-enabled, or if the user prefers to use a larger display than the camera viewer, a host processing system (separate from the camera) can be employed to display images, URL links, and resources. Referring to FIG. 5, an exemplary processing system 500 for associating URL link data with images according to the present invention includes a computer 502, a computer usable medium 504, a display 506, a user input mechanism 508, and Internet (or other network) connection hardware 510 configured as shown. Information can be transferred from the camera 104 to the processing system 500 in a variety of different ways. Wireless connections can be made using IR technology to establish a communications interface between the camera 104 and processing system 500. Wireless connections can also be RF-based, such as IEEE 802.11 or Bluetooth. Alternatively, wired connections such as IEEE 1394, USB, serial, etc. can be employed.

In one embodiment, the computer usable medium 504 has computer-readable instructions thereon for causing the computer 502 to process image data including embedded URL link data from a camera to generate a visual representation of one or more images associated with the image data and one or more URL links associated with the URL link data. In another embodiment, the computer-readable instructions cause the computer 502 to establish a communications link to one or more resources associated with the one or more URL links. According to an exemplary method for associating URL link data with images created by a camera of the present invention, the images and/or the URL links are reproduced by a computer system separate from the camera.

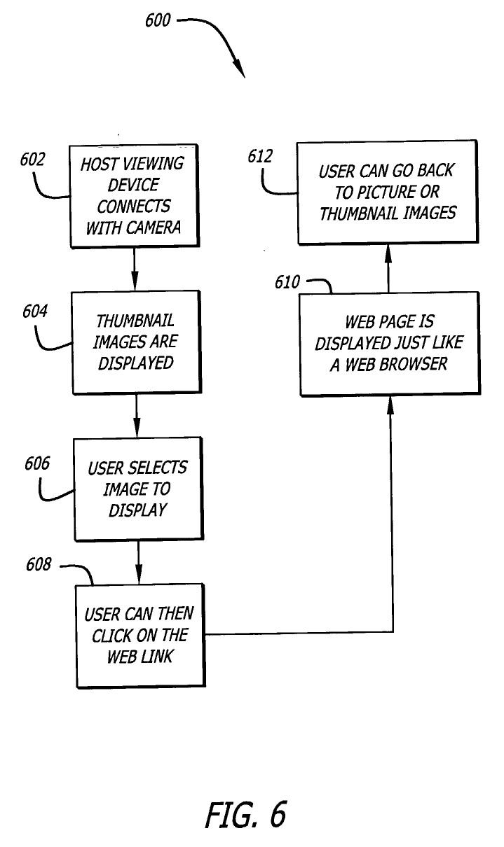

Referring to FIG. 6, an exemplary method 600 for employing a processing system to establish a communications link to a resource such as a Web page according to the present invention begins at step 602 with establishing a connection between the camera 104 and the processing system 500 (host viewing device) and effecting the data transfer. At step 604, thumbnail images are displayed on the monitor 506. At step 606, the users selects (e.g., using a user input mechanism such as a keyboard, mouse, etc.) an image to display from the menu of thumbnail images. With the selected image and any URL links associated therewith now displayed, at step 608, the user can select and activate a displayed URL link. At step 610, a resource associated with the activated URL link is displayed on the monitor 506. At step 612, the user can “go back” to the image or thumbnail images as desired. Thus, in one embodiment, the host viewing device is configured to operate in a manner similar to a Web browser allowing the user to back up to previous images, click on additional links, etc.

The principles of the present invention can also be employed to create a digital photo album that includes URL links stored along with images. By way of example, such URL links can be activated by clicking on the URL link, the title of the URL link, and/or the digital image. The digital photo album can be e-mailed or ftp'ed, providing recipients with the same access to the images and the associated URLs.

In one embodiment of the present invention, a user cannot override (or undo) the embedding of the URL link data with the images. This prevents the inadvertent deletion of text messages and URL link data from the stored data. Such a configuration may also be desirable when the linked resources include advertising messages or other content. For example, an amusement or theme park might sell “beacon advertising space” to advertisers, thereby giving these advertisers means for injecting their advertisements into the captured images taken by patrons of the park. Thus, in an embodiment of the present invention, the camera and/or host processing system is/are configured such that it is not possible to disable or remove advertising URL link data that has been embedded with the image data. Such advertisement URL links can be embedded alone or with non-advertisement URL links. In one embodiment, advertisement URL links automatically remove themselves after the resources associated with them have been viewed. In another embodiment, advertisement URL links automatically activate to generate “pop-up” ads whenever the image is viewed for the first time. For example, if a “promotional camera” is given away, or sold at a reduced price, it may be desirable to compel recipients of this product to view certain resources as a quid pro quo for receiving the camera at such a bargain price. Thus, in various embodiments of the present invention, URL link data other than that specifically requested by the camera operator are (also) associated with the captured images.

In another embodiment of the present invention, the camera and/or host processing system is/are configured such that the user can disable (or remove) URL link data, advertising URL link data, or a subset of advertising URL link data such as links that activate “pop-up” ads which are annoying to many people. Thus, in other embodiments of the present invention, the URL link data are associated with the images in response to an input provided by a user of the camera and/or host operating system.

Although the present invention has been described in terms of the preferred embodiment above, numerous modifications and/or additions to the above-described preferred embodiment would be readily apparent to one skilled in the art. It is intended that the scope of the present invention extends to all such modifications and/or additions.

We claim:

1. A method for associating uniform resource locator (URL) link data with images created by an image capture device, comprising:
initiating transmission of a signal communicating URL link data; and
employing an image capture device configured with a receiver and processor electronics to receive and process the signal and to associate the URL link data with an image generated by the image capture device.

2. The method for associating uniform resource locator (URL) link data with images created by an image capture device of claim 1, wherein the image capture device is configured to generate a data file that includes image data and the URL link data associated with image.

3. The method for associating uniform resource locator (URL) link data with images created by an image capture device of claim 2, further comprising:
processing the image data to reproduce the image.

4. The method for associating uniform resource locator (URL) link data with images created by an image capture device of claim 3, wherein the image is reproduced by the image capture device.

5. The method for associating uniform resource locator (URL) link data with images created by an image capture device of claim 3, wherein the image is reproduced by a computer system separate from the image capture device.

6. The method for associating uniform resource locator (URL) link data with images created by an image capture device of claim 1, further comprising:
processing the URL link data to generate a URL link.

7. The method for associating uniform resource locator (URL) link data with images created by an image capture device of claim 6, wherein the URL link is generated by the image capture device.

8. The method for associating uniform resource locator (URL) link data with images created by an image capture device of claim 6, wherein the URL link is generated by a computer system separate from the image capture device.

9. The method for associating uniform resource locator (URL) link data with images created by an image capture device of claim 6, further comprising:
employing the URL link to establish a communications link to a resource associated with the URL.

10. The method for associating uniform resource locator (URL) link data with images created by an image capture device of claim 9, wherein the resource comprises a Web page.

11. A method for associating uniform resource locator (URL) link data with images created by an image capture device, comprising:
providing a plurality of broadcast beacons at different locations;
controlling the broadcast beacons to transmit signals communicating URL link data; and
employing an image capture device configured with a receiver and processing electronics to receive one or more of the signals and to associate the URL link data with images generated by the image capture device.

12. The method for associating uniform resource locator (URL) link data with images created by a camera of claim 11, wherein the broadcast beacons comprise radio frequency (RF) transmitters.

13. The method for associating uniform resource locator (URL) link data with images created by an image capture device of claim 11, wherein the broadcast beacons comprise infra-red devices.

14. The method for associating uniform resource locator (URL) link data with images created by an image capture device of claim 11, wherein the URL link data are associated with the images in response to an input provided by a user of the image capture device.

15. The method for associating uniform resource locator (URL) link data with images created by an image capture device of claim 11, wherein the URL link data are automatically associated with the images.

16. The method for associating uniform resource locator (URL) link data with images created by an image capture device of claim 11, wherein the URL link data are permanently associated with the images.

17. The method for associating uniform resource locator (URL) link data with images created by an image capture device of claim 11, further comprising:
storing the URL link data with the images in a non-volatile memory device.

18. The method for associating uniform resource locator (URL) link data with images created by an image capture device of claim 11, further comprising:
employing the URL link data to establish a wireless communications link to a resource.

19. The method for associating uniform resource locator (URL) link data with images created by an image capture device of claim 18, further comprising:
generating a bill to, or debiting an account associated with, a provider of the resource.

20. The method for associating uniform resource locator (URL) link data with images created by an image capture device of claim 18, wherein the resource comprises an advertisement.

21. The method for associating uniform resource locator (URL) link data with images created by an image capture device of claim 18, wherein the resource comprises a Web page.

22. A method for associating uniform resource locator (URL) link data with images created by an image capture device, comprising:
providing an image capture device with a receiver and processing electronics configured for receiving and processing a signal communicating text message and/or URL link data and for associating the text message and/or URL link data with one or more images generated by the image capture device.

23. A system for associating uniform resource locator (URL) link data with images, comprising:
an image capture device; and
means for receiving and processing a signal communicating URL link data and for associating the URL link data with one or more images generated by the image capture device.

24. The system for associating uniform resource locator (URL) link data with images of claim 23, wherein the image capture device is configured to generate a visual representation of the URL link data.

25. The system for associating uniform resource locator (URL) link data with images of claim 23, wherein the image capture device is configured to employ the URL link data to establish a wireless communication link to a resource.

26. The system for associating uniform resource locator (URL) link data with images of claim 25, wherein the image capture device is configured to generate a visual representation of the resource.

27. A processing system for associating uniform resource locator (URL) link data with images, comprising:
a computer configured to receive and process image data including embedded URL link data from an image capture device to generate a visual representation of one or more images associated with the image data and one or more URL links associated with the URL link data.

28. The processing system for associating uniform resource locator (URL) link data with images of claim 27, wherein the computer is configured to allow a user to select one or more of the URL links and to establish a communications link to one or more resources associated with the URL link(s).

29. A computer program for associating uniform resource locator (URL) link data with images, comprising:
a computer usable medium having computer-readable instructions thereon for causing a computer to process image data including embedded URL link data from an image capture device to generate a visual representation of one or more images associated with the image data and one or more URL links associated with the URL link data.

30. The computer program for associating uniform resource locator (URL) link data with images of claim 29, wherein the computer-readable instructions cause the computer to establish a communications link to one or more resources associated with the one or more URL links.
